(19) United States
(12) Patent Application Publication
(10) Pub. No.: US 2004/0104995 A1
(43) Pub. Date: Jun. 3, 2004

(54) Information processing system, information processing method, information processing apparatus, and program

(75) Inventors: Junji Ooi, Kanagawa (JP); Masahiro Kobayashi, Tokyo (JP); Haruhiko Sakata, Kanagawa (JP); Masahiro Fujihara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/642,601

(22) Filed: Aug. 19, 2003

(30) Foreign Application Priority Data
Sep. 6, 2002 (JP) 2002-260717

(51) Int. Cl. H04N 7/14

(52) U.S. Cl. 348/14.01; 348/14.08

(57) ABSTRACT

A connection is reliably made between devices having either unidirectional or bidirectional moving-image streaming function, so that information can be transferred. Each terminal notifies a connection server about which one of a bidirectional function and a unidirectional function the terminal has. The connection server notifies the functions of each terminal to the other terminals. The terminal having a unidirectional function transmits a URI for transmitting data to a terminal having a bidirectional function, with which communication is performed, but the terminal having the bidirectional function, which communicates with the terminal having a unidirectional function, does not transmit a URI used to transmit data to the terminal having a unidirectional function. The present invention can be applied to a personal computer which transfers communication data in the Internet.

### BACKGROUND OF THE INVENTION

1. Field of the Invention

The present invention relates to an information processing system, an information processing method, an information processing apparatus, and a program. More particularly, the present invention relates to an information processing system, in which a connection between apparatuses having different capabilities is ensured, to an information processing method therefor, to an information processing apparatus therefor, and to a program therefor.

2. Description of the Related Art

In a conventional videophone connection system, a method has been proposed in which, with regard to a communicating party, by determining the presence or absence of image data by the communication capacity even when the selection of communication capabilities cannot be performed appropriately due to the difference in kinds of devices with which communication is performed, the difference in communication protocols, variations in the line capacity, etc., the continued display of useless images to a user is prevented (refer to, for example, Japanese Unexamined Patent Application Publication No. 4-223755).

However, in the method described in Japanese Unexamined Patent Application Publication No. 4-223755, there are problems in that the user cannot know about whether or not video images can be transferred bidirectionally to and from the other party until a connection is made. Furthermore, another problem is that, when many types of devices are connected to the system, the algorithm that discriminates between those devices becomes complicated.

### SUMMARY OF THE INVENTION

The present invention has been made in view of such circumstances. An object of the present invention is to allow a connection to be made simply and reliably with devices of the other party, and in particular, to allow for even a device which can communicate only unidirectionally to reliably communicate with a device capable of bidirectional communication.

To achieve the above-mentioned object, in one aspect, the present invention provides an information processing system having a first information processing apparatus and a second information processing apparatus for transferring information via a network, the information processing system including: first execution means for performing a connection procedure for transferring main information from the first information processing apparatus to the second information processing apparatus; and second execution means for determining whether the first information processing apparatus has a bidirectional function for transmitting the main information and for receiving the main information, or has a unidirectional function such that the first information processing apparatus has a transmission function but not a receiving function, and for performing a connection procedure for transferring the main information from the second information processing apparatus to the first information processing apparatus.

In the connection procedure for transferring the main information, one of the first information processing apparatus and the second information processing apparatus may transmit, to the other apparatus, information of the connection destination to which the main information is to be transmitted or from which the main information is to be received.

One of the first information processing apparatus and the second information processing apparatus may transmit, to the other apparatus, invitation information for inviting a connection, and the information processing apparatus receiving the invitation information may transmit acceptance information indicating that the invitation is received, to the information processing apparatus that has transmitted the invitation information when the invitation based on the invitation information is to be accepted.

One of the first information processing apparatus and the second information processing apparatus may transmit, to the other apparatus, function information indicating which one of the bidirectional function and the unidirectional function the apparatus itself has.

One of the first information processing apparatus and the second information processing apparatus may determine whether or not the other party is able to communicate with the apparatus itself when the function information is received from the other party, and when the other party is able to communicate with the apparatus itself, the apparatus itself may be registered in the other party.

The information processing system may further include a third information processing apparatus for transmitting the function information of one of the first information processing apparatus and the second information processing apparatus to the other party via the network.

To transfer the main information, the connection procedure performed between the first information processing apparatus and the second information processing apparatus may be performed via the third information processing apparatus connected to the network, and the transfer of the main information between the first information processing apparatus and the second information processing apparatus may be performed without the intervention of the third information processing apparatus.

In another aspect, the present invention provides an information processing system having a first information processing apparatus and a second information processing apparatus for transferring information via a network, the information processing system including: first execution means for performing a connection procedure for transferring main information in a first direction between the first information processing apparatus and the second information processing apparatus; and second execution means for determining whether at least one of the first information processing apparatus and the second information processing apparatus has a bidirectional function for transmitting the main information and for receiving the main information, or has a unidirectional function such that the apparatus has a transmission function but not a receiving function, and for performing a connection procedure for transferring the main information in a second direction differing from the first direction.

In another aspect, the present invention provides an information processing method for use in an information processing system including a first information processing apparatus and a second information processing apparatus for transferring information via a network, the information processing method including the steps of: performing a connection procedure for transferring main information from the first information processing apparatus to the second information processing apparatus; determining whether the first information processing apparatus has a bidirectional function for transmitting the main information and for receiving the main information, or has a unidirectional function such that the first information processing apparatus has a transmission function but not a receiving function; and performing a connection procedure for transferring the main information from the second information processing apparatus to the first information processing apparatus when the first information processing apparatus has the bidirectional function.

In another aspect, the present invention provides an information processing method for use in an information processing system including a first information processing apparatus and a second information processing apparatus for transferring information via a network, the information processing method including the steps of: performing a connection procedure for transferring main information in a first direction between the first information processing apparatus and the second information processing apparatus; determining whether at least one of the first information processing apparatus and the second information processing apparatus has a bidirectional function for transmitting the main information and for receiving the main information, or has a unidirectional function such that the apparatus has a transmission function but not a receiving function; and performing a connection procedure for transferring the main information in a second direction differing from the first direction when the bidirectional function is possessed.

In another aspect, the present invention provides an information processing apparatus for receiving information from a second information processing apparatus via a network, the information processing apparatus including: communication means for transmitting and receiving information; and control means for performing various processes, wherein the control means performs: a first execution process for executing a connection procedure for receiving main information transmitted by the second information processing apparatus; a determination process for determining whether the second information processing apparatus has a bidirectional function for transmitting the main information and for receiving the main information, or has a unidirectional function such that the second information processing apparatus has a transmission function but not a receiving function; and a second execution process for executing a connection procedure for the second information processing apparatus to receive the main information transmitted by the information processing apparatus when it is determined in the determination process that the second information processing apparatus has the bidirectional function.

In the second execution process, when it is determined in the determination process that the second information processing apparatus has the unidirectional function, the connection procedure for the second information processing apparatus to receive the main information transmitted by the information processing apparatus may be skipped.

In the first execution process, first connection information for receiving the main information transmitted by the second information processing apparatus may be exchanged with the second information processing apparatus, and, in the second execution process, second connection information used by the second information processing apparatus to receive the main information transmitted by the information processing apparatus may be exchanged with the second information processing apparatus.

In the first execution process, the first connection information may be received from the second information processing apparatus, and in the second execution process, the second connection information may be transmitted to the second information processing apparatus.

The control means may perform a process for communicating with the second information processing apparatus on the basis of at least one of the first connection information and the second connection information.

The control means may perform a process for receiving invitation information for inviting a connection from the second information processing apparatus via the communication means and for transmitting acceptance information indicating that the invitation is accepted, to the second information processing apparatus via the communication means when the invitation based on the invitation information is to be accepted.

The control means may further perform a process for receiving, via the communication means, function information indicating which one of the bidirectional function and the unidirectional function the second information processing apparatus has, and the determination process may determine which one of the bidirectional function and the unidirectional function the second information processing apparatus has.

The control means may perform a process for determining whether or not communication with the second information processing apparatus is possible when the function information is received, and may perform a process for registering the information processing apparatus in the second information processing apparatus when communication with the second information processing apparatus is possible.

The control means may further perform a process for transmitting the function information of the information processing apparatus to the second information processing apparatus via the communication means.

The function information may be transmitted to the second information processing apparatus via a third information processing apparatus on the network.

The function information of the second information processing apparatus may be received via the third information processing apparatus on the network.

To transfer the main information, the connection procedure performed with the second information processing apparatus may be performed via the third information processing apparatus connected to the network, and the main information transferred to and from the second information processing apparatus may be transferred without the intervention of the third information processing apparatus.

In another aspect, the present invention provides an information processing method for receiving information from a communication party via a network, the information processing method including: a first execution step of executing a connection procedure for receiving main information transmitted by the communication party; a determination step of determining whether the communication party has a bidirectional function for transmitting the main information and for receiving the main information, or has a unidirectional function such that the communication party has a transmission function but not a receiving function; and a second execution step of executing a connection procedure for transmitting the main information when it is determined in the process of the determination step that the communication party has the bidirectional function.

In another aspect, the present invention provides a computer program for allowing a computer to perform a process for receiving information from a communication party via a network, the computer program including: a first execution step of executing a connection procedure for receiving main information transmitted by the communication party; a determination step of determining whether the communication party has a bidirectional function for transmitting the main information and for receiving the main information, or has a unidirectional function such that the communication party has a transmission function but not a receiving function; and a second execution step of executing a connection procedure for transmitting the main information to the communication party when it is determined in the determination process that the communication party has the bidirectional function.

In another aspect, the present invention provides an information processing apparatus for transmitting information to a second information processing apparatus via a network, the information processing apparatus including: communication means for transmitting and receiving information; and control means for performing various processes, wherein the control means performs: a first execution process for executing a connection procedure for transmitting main information to the second information processing apparatus; a determination process for determining whether the second information processing apparatus has a bidirectional function for transmitting the main information and for receiving the main information, or has a unidirectional function such that the second information processing apparatus has a transmission function but not a receiving function; and a second execution process for executing a connection procedure for the information processing apparatus to receive the main information transmitted by the second information processing apparatus when it is determined in the determination process that the second information processing apparatus has the bidirectional function.

In the second execution process, when it is determined in the determination process that the second information processing apparatus has the unidirectional function, the connection procedure for the information processing apparatus to receive the main information transmitted by the second information processing apparatus may be skipped.

In the first execution process, first connection information used by the second information processing apparatus to receive the main information transmitted by the information processing apparatus may be exchanged with the second information processing apparatus, and in the second execution process, second connection information used by the information processing apparatus to receive the main information transmitted by the second information processing apparatus may be exchanged with the second information processing apparatus.

In the first execution process, the first connection information may be transmitted to the second information processing apparatus, and in the second execution process, the second connection information may be received from the second information processing apparatus.

The control means may perform a process for communicating with the second information processing apparatus on the basis of at least one of the first connection information and the second connection information.

The control means may further perform a process for transmitting invitation information, for inviting a connection, to the second information processing apparatus via the communication means, and the first execution process may transmit the first connection information to the second information processing apparatus when the invitation based on the invitation information is accepted.

The control means may further perform a process for receiving, via the communication means, function information indicating which one of the bidirectional function and the unidirectional function the second information processing apparatus has the function information being transmitted by the second information processing apparatus, and the determination process may determine, on the basis of the received function information, which one of the bidirectional function and the unidirectional function the second information processing apparatus has.

The control means may perform a process for determining whether or not communication with the second information processing apparatus is possible when the function information is received, and may perform a process for registering the information processing apparatus in the second information processing apparatus when communication with the second information processing apparatus is possible.

The control means may further perform a process for transmitting the function information of the information processing apparatus to the second information processing apparatus via the communication means.

The function information may be transmitted to the second information processing apparatus via a third information processing apparatus on the network.

The function information of the second information processing apparatus may be received via the third information processing apparatus on the network.

To transfer the main information, the connection procedure performed with the second information processing apparatus may be performed via the third information processing apparatus connected to the network, and the main information transferred to and from the second may be transferred without the intervention of the third information processing apparatus.

In another aspect, the present invention provides an information processing method for transmitting main information to a communication party via a network, the information processing method including: a first execution step of executing a connection procedure for transmitting main information to the communication party; a determination step of determining whether the communication party has a bidirectional function for transmitting the main information and for receiving the main information, or has a unidirectional function such that the communication party has a transmission function but not a receiving function; and a second execution step of executing a connection procedure for receiving the main information transmitted by the information processing apparatus when it is determined in the process of the determination step that the communication party has the bidirectional function.

In another aspect, the present invention provides a computer program for allowing a computer to perform a process for transmitting information to a communication party via a network, the computer program including: a first execution step of executing a connection procedure for transmitting main information to the communication party; a determination step of determining whether the communication party has a bidirectional function for transmitting the main information and for receiving the main information, or has a unidirectional function such that the communication party has a transmission function but not a receiving function; and a second execution step of executing a connection procedure for receiving the main information transmitted by the communication party when it is determined in the determination process that the communication party has the bidirectional function.

As described above, according to the present invention, it is possible to realize a system in which a device having a unidirectional function can transmit information to a device having a bidirectional function. In particular, even if the other party is a device having a unidirectional function, it is possible to realize a system in which the device having a bidirectional function can receive information by the same procedure as that when the other party is a device having a bidirectional function.

According to the present invention, information can be received from both a device having a bidirectional function and a device having a unidirectional function. In particular, even if the device of the other party is any one of a device having a bidirectional function and a device having a unidirectional function, information can be received by the same procedure as that when the other party is a device having a bidirectional function.

According to the present invention, information can be transmitted to both a device having a uidirectional function and a device having a bidirectional function. In particular, even if the device of the other party is any one of a device having a bidirectional function and a device having a unidirectional function, information can be transmitted by the same procedure as that when the other party is a device having a bidirectional function.

### BRIEF DESCRIPTION OF THE DRAWINGS

FIG. 1 is a diagram showing the configuration of a network system to which the present invention is applied;

FIG. 2 is a diagram showing the configuration of a terminal in FIG. 1;

FIG. 3 is a diagram showing the configuration of another terminal in FIG. 1;

FIG. 4 is a flowchart illustrating the operation of the network system in FIG. 1;

FIG. 5 shows an example of capability items;

FIG. 6 shows an example of data of a terminal having a bidirectional function;

FIG. 7 is a flowchart illustrating the transmission operation of the terminal in FIG. 1;

FIG. 8 is a flowchart illustrating the reception operation of the terminal in FIG. 1;

FIG. 9 is a flowchart illustrating another operation of the network system in FIG. 1; and

FIG. 10 shows an example of data of a terminal having a unidirectional function.

### DESCRIPTION OF THE PREFERRED EMBODIMENTS

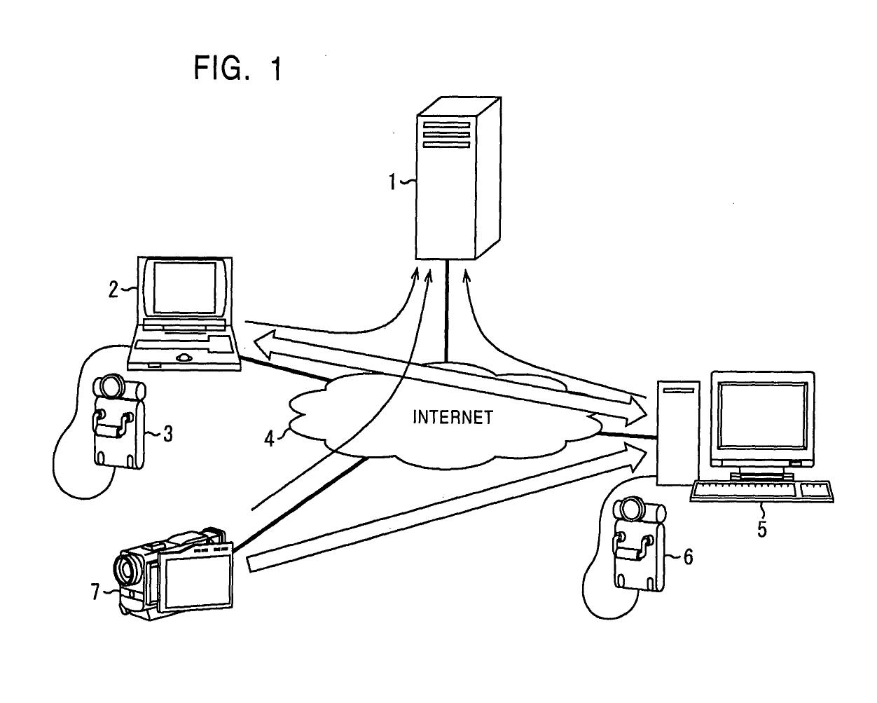

FIG. 1 is a diagram showing an example of the configuration of a network system to which the present invention is applied. In this network system, a terminal 2, a terminal 5, and a terminal 7 are connected to a connection server 1 formed of a personal computer via the Internet 4. A digital still camera 3 and a digital still camera 6 are respectively connected to the terminal 2 and the terminal 5, which are personal computers. The terminal 2 and the terminal 5 are capable of bidirectionally communicating image data, that is, they are capable of performing transmission and reception. The terminal 7, which is formed of a portable video camera, is a terminal capable of communicating image data unidirectionally, that is, it is capable of performing only transmission (reception is not possible).

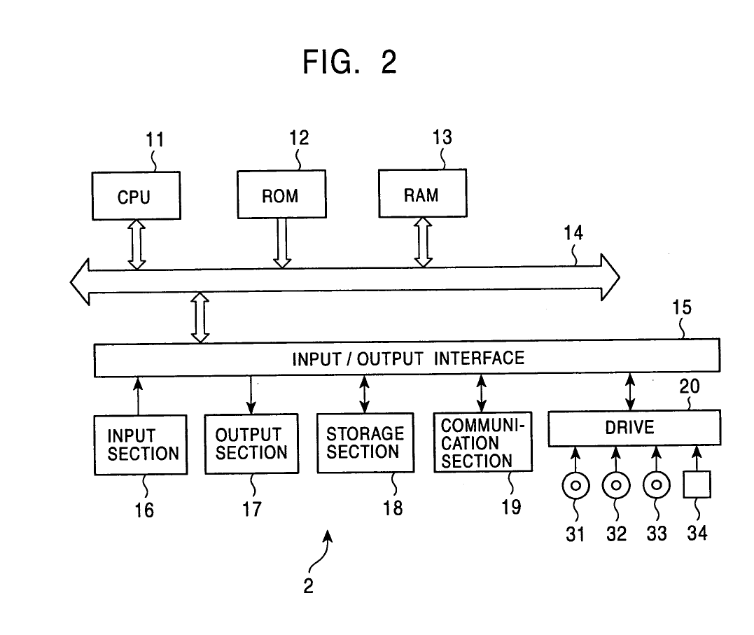

FIG. 2 shows an example of the configuration of the terminal 2. Although not shown, the terminal 5 and the connection server 1 are also configured in the same way. Therefore, in the following, the configuration of FIG. 2 is given as an example of the configuration of the terminal 5 or the connection server 1 as necessary.

In FIG. 2, a CPU (Central Processing Unit) 11 performs various processes in accordance with a program stored in a ROM (Read Only Memory) 12 or a program loaded from a storage section 18 into a RAM (Random Access Memory) 13. In the RAM 13, data required for the CPU 11 to perform various processes are stored appropriately.

The CPU 11, the ROM 12, and the RAM 13 are interconnected with one another via a bus 14. An input/output interface 15 is also connected to the bus 14.

An input section 16 including a keyboard, a mouse, etc.; a display device including a CRT (Cathode Ray Tube) or an LCD (Liquid-Crystal Display); an output section 17 including a speaker, etc.; the storage section 18 including a hard disk; and a communication section 19 including a modem, a terminal adapter, etc., are connected to the input/output interface 15. The communication section 19 performs communication processes via a network, including the Internet 4.

A drive 20 is also connected to the input/output interface 15 as necessary. A magnetic disk 31, an optical disk 32, a magneto-optical disk 33, or a semiconductor memory 34 is loaded into the drive 20 as appropriate, so that a computer program read therefrom is installed into the storage section 18.

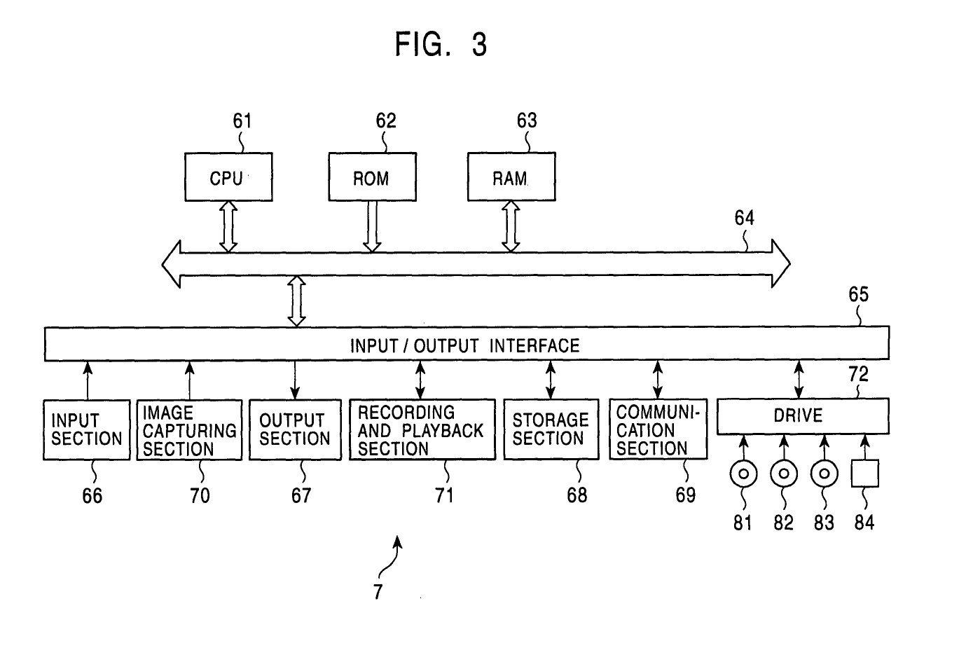

FIG. 3 shows an example of the configuration of the terminal 7. The configuration of FIG. 3 is nearly the same as the configuration of FIG. 2, and as a digital still camera, an image capturing section 70 for capturing an image of a subject and a recording and playback section 71 for recording and playing back the image-captured data are connected to an input/output interface 65. The components from a CPU 61 to a communication section 69 have the same functions as those of the CPU 11 to the communication section 19 of FIG. 2. Furthermore, a drive 72, and devices from a magnetic disk 81 to a semiconductor memory 84 connected to the drive 72, have the same functions as those of the drive 20, and devices from the magnetic disk 31 to the semiconductor memory 34 connected to the drive 20 of FIG. 2.

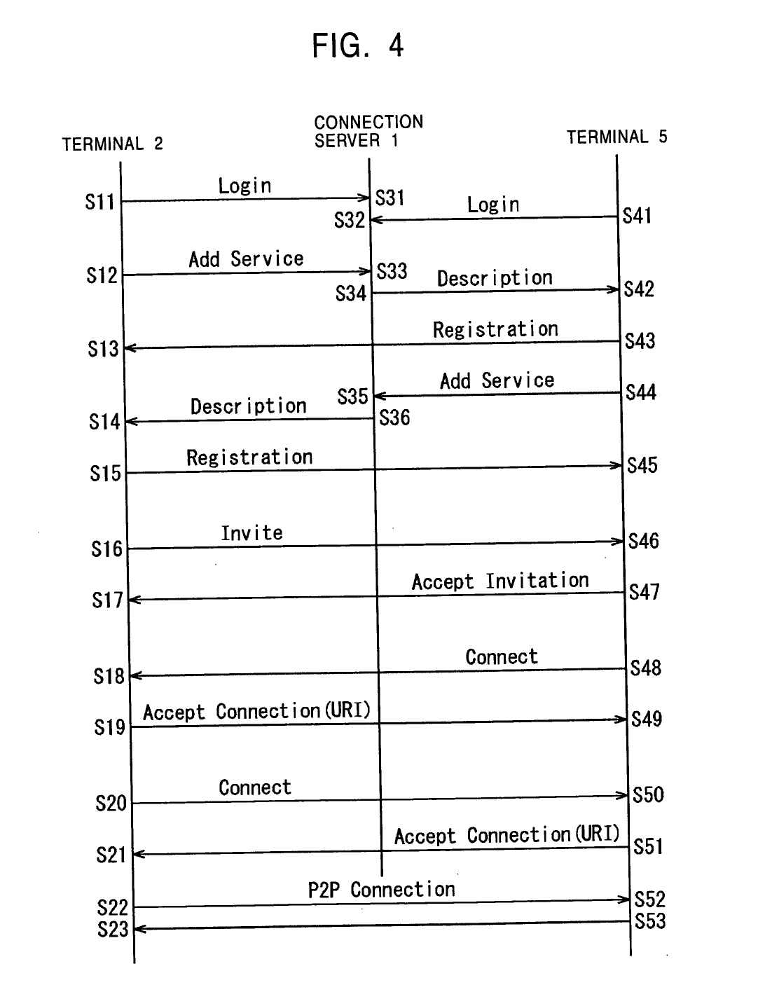

A description will now be given, with reference to the flowchart in FIG. 4, of a process for connecting the terminal 2 and the terminal 5, which are capable of transferring images bidirectionally.

In step S1, the CPU 1.1 of the terminal 2 controls the communication section 19 in order to log in the connection server 1 via the Internet 4. In step S41, the CPU 11 of the terminal 5 controls the communication section 19, and accesses and logs in the connection server via the Internet 4. The CPU 11 of the connection server 1 accepts the log-in from the terminal 2 and the terminal 5 in step S31 and in step S32, respectively, from the Internet 4 via the communication section 19.

In step S12, the CPU 11 of the terminal 2 transmits the capabilities of the CPU 11 itself (the functions of the CPU 11 itself) to the connection server 1, and requests that these be registered (Add Service). In step S33, when the CPU 11 of the connection server 1 receives the capabilities of the terminal 2, the CPU registers them in the storage section 18, and notifies the contents (Description) to the terminal 5 in step S34.

When this notification is received, in step S42, the CPU 11 of the terminal 5 determines whether or not a match with the functions of its own CPU 11 is made on the basis of the contents (Description). When a match is made, in step S34, the CPU 11 requests the terminal 2 that the terminal 5 itself be registered as a party with which communication is possible. In step S13, based on this request, the CPU 11 of the terminal 2 registers the terminal 5 as a party with which communication is possible in the storage section 18.

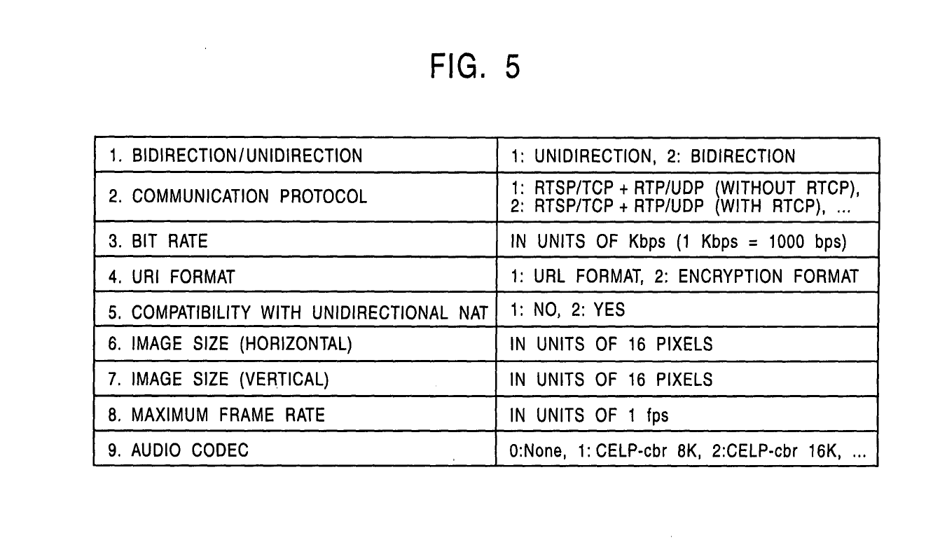

The capability items to be registered are shown in FIG. 5. Nine items are represented by using numerical values. The item “1. Bidirection/Unidirection” is an item for transmission and reception functions; “1” indicates unidirection (only transmission), and “2” indicates bidirection (transmission and reception). The item “2. Communication Protocol” is an item concerning the protocol used for communication; “1” indicates RTSP (Real Time Streaming Protocol)/TCP (Transmission Control Protocol)+RTP (Real-Time Transport Protocol)/UDP (User Datagram Protocol) (without RTCP (Real-Time Transport Control Protocol)), and “2” indicates RTSP/TCP+RTP/UDP (with RTCP). The item “3. Bit Rate” is an item concerning the communication speed, and a numerical value normalized in units of Kbps is shown. The item “4. URI (Uniform Resource Identifier) format” represents the URI representation format; “1” indicates the URL (Uniform Resource Locator) format, and “2” indicates the encryption format.

The item “5. Compatibility with Unidirectional NAT (Network Address Translation)” represents the presence or absence of a NAT function; “1” indicates NO, and “2” indicates YES. The items “6. Image Size (Horizontal)” and “7. Image Size (Vertical)” represent the horizontal and vertical sizes of the angle of view, respectively, and the sizes are shown by using numerical values normalized in units of 16 pixels. The item “8. Maximum Frame Rate” is shown by being normalized in units of 1 fps. The item “9. Audio Codec” represents the audio compression and decompression method; “0” indicates None, “1” indicates CELP-cbr (Code Excited Linear Predictive constant bit rate) 8 k, and “2” indicates CELP-cbr 16 k.

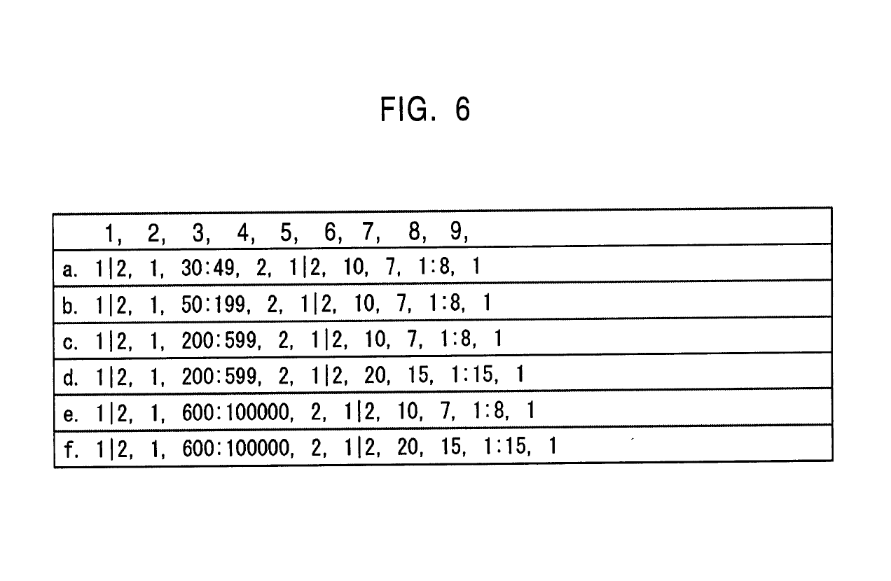

Examples of the data, shown in the above items, representing the capabilities of the devices, which is transmitted in step S12 and is registered in step S33, are shown in FIG. 6. Here, six examples from “a” to “f” are shown, and nine items are shown by using a one-dimensional array of numerical values in sequence starting from the left side in the figure. Here, in the data “a”, “112” of item 1 indicates “1” or “2”, and the function is compatible with both bidirection and unidirection. “30:49” of item 3 indicates a range from 30 to 49, and this indicates that the bit rate is from 30 Kbps to 49 Kbps.

Referring back to FIG. 4, processes similar to the capability notification processes performed in the terminal 5 by the terminal 2 via the connection server 1 (processes of steps S12 and S13, steps S33 and S34, and steps S42 and S43) are conversely performed in the terminal 2 by the terminal 5. These processes are performed in step S14 and S15 in the terminal 2, in step S35 and S36 in the connection server 1, and in step S44 and S45 in the terminal 5. That is, as a result, the terminal 2 is registered as a party with which communication is possible in the storage section 18 of the terminal 5.

In this manner, after it is confirmed that mutual communication is possible between the terminal 2 and the terminal 5, a connection is established in the following manner between them without the intervention of the connection server 1.

More specifically, in step S16, the CPU 11 of the terminal 2 controls the communication section 19 in order to transmit an Invite command to the terminal 5 via the Internet 4. In step S46, when the CPU 11 of the terminal 5 receives the Invite command, the CPU 11 displays, on the display of the output section 17, the fact that an invitation is presented from the terminal 2. The user views the display and determines whether the invitation should be accepted or rejected. When a rejection is instructed, a rejection response is transmitted from the terminal 5 to the terminal 2, and a connect process after that is not performed.

In contrast, when the user operates the input section 16 and instructs acceptance, in step S47, the CPU 11 of the terminal 5 controls the communication section 19 in order to notify the terminal 2 that the invitation is accepted (notify Accept Invitation). That is, at this time, the Accept command is transmitted to the terminal 2. In step S17, the CPU 11 of the terminal 2 receives the Accept command.

After the Accept command is transmitted, in step S48, the CPU 11 of the terminal 5 controls the communication section 19 in order to transmit a Connect command, for requesting a connection, to the terminal 2 via the Internet 4. In step S18, when the CPU 11 of the terminal 2 receives the Connect command, the CPU 11 transmits the Accept command in step S19. This command contains a URI used by the terminal 2 to transmit data to the terminal 5.

In this manner, after the URI is notified from the terminal 2 to the terminal 5, the terminal 5 causes similar processes to be performed in the terminal 2. These processes are performed in steps S20 and S21 in the terminal 2, and in steps S50 and S51 in the terminal 5. That is, in step S20, the CPU 11 of the terminal 2 controls the communication section 19 in order to transmit a Connect command, for requesting a connection, to the terminal 5 via the Internet 4. In step S50, when the CPU 11 of the terminal 5 receives the Connect command, the CPU 11 transmits an Accept Connection command in step S51.

In the above processes, the Accept Connection command allows mutual URIs to be transmitted, and in steps S22 and S23 and in steps S52 and S53, a peer-to-peer (P2P) connection between the terminal 2 and the terminal 5 is established. That is, in step S22, when the terminal 5 accesses the URI of the terminal 2, which is transmitted in the process of step S19, the CPU 11 of the terminal 2 transmits data (for example, AV (Audio Visual) data such as image data, audio data, etc.) to the terminal 5 on the basis of the URI. The CPU 11 of the terminal 5 receives the data in step S52.

Similarly, in step S53, when the terminal 2 accesses the URI of the terminal 5, which is transmitted in the process of step S51, the CPU 11 of the terminal 5 transmits data (for example, AV data such as image data, audio data, etc.) to the terminal 2 on the basis of the URI. The CPU 11 of the terminal 2 receives the data in step S23.

In the above, although the connection (processes of steps S22 and S52) for transmitting data from the terminal 2 to the terminal 5 is performed after the procedure (steps S20, S21, S50, and S51) for transmitting data from the terminal 5 to the terminal 2, the connection may be performed before that (immediately after steps S18, S19, S48, and S49). That is, the connection may be made in sequence one direction at a time.

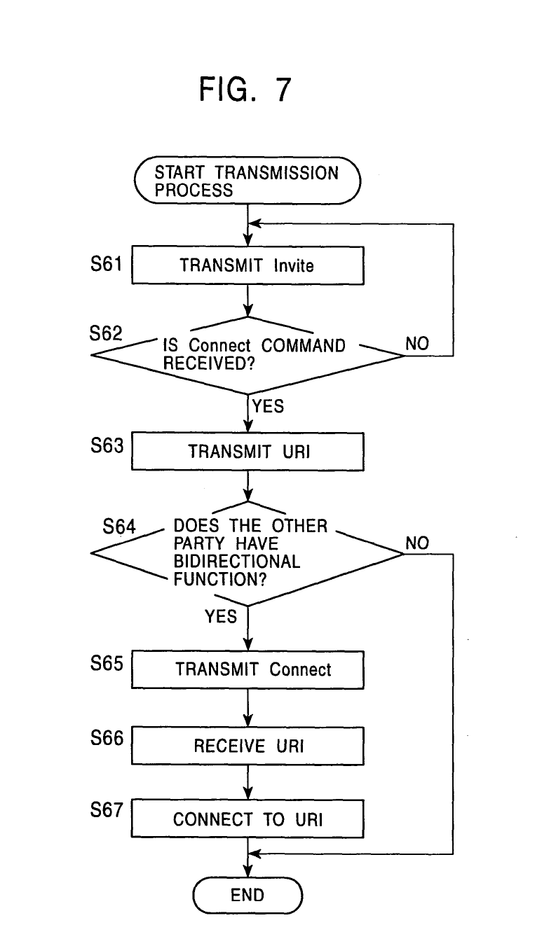

FIG. 7 is a flowchart showing the operation of the terminal 2 (the transmission side) for the processes in FIG. 4. In step S61 (corresponding to step S16 of FIG. 4), after the CPU 11 of the terminal 2 transmits the Invite command to the terminal 5, the CPU 11 determines in step S62 whether or not the Connect command is received from the terminal 5. If the Connect command is not received, the process returns to step S61, where the above process is repeated. That is, this process is repeated until the Connect command is received in the process of step S18 of FIG. 4. However, if a rejection response is received or if the Connect command is not received after a predetermined time has elapsed, the processing is terminated.

When it is determined in step S62 that the Connect command is received from the terminal 5, the CPU 11 of the terminal 2 transmits the URI stored in the storage section 18 to the terminal 5 in accordance with the Accept Connection command in step S63 (corresponding to step S19 of FIG. 4).

In step S64, the CPU 11 of the terminal 2 determines whether or not the device (terminal 5) of the other party has a bidirectional function. When it is determined that the device has a bidirectional function (when the item “1. Bidirection/Unidirection”, among the functions of the terminal 5, shown in FIG. 5, which are received in the process of step S14, contains “2”, that is, when the item is “1|2” or is “2”, in other words, the item is not “1” (when at least the receiving function is possessed)), the Connect command is transmitted in step S65 (corresponding to step S20 of FIG. 4).

Then, in the manner described above, since the Accept Connection command is transmitted from the terminal 5 (step S51 of FIG. 4), in step S66 (corresponding to step S21 of FIG. 4), the URI of the device (the terminal 5) of the other party is received, and a connection is made to the URI in step S67 (corresponding to step S22 of FIG. 4).

When it is determined in step S64 that the device (the terminal 5) of the other party has only the unidirectional function (when the item “1. Bidirection/Unidirection”, among the functions of the terminal 5, shown in FIG. 5, which are received in the process of step S14, is “1|2”, or when the item is not “2”, but “1” (when the receiving function is not possessed)), the Connect processes of steps S65 to S67 are skipped (prohibited), and the processing is terminated.

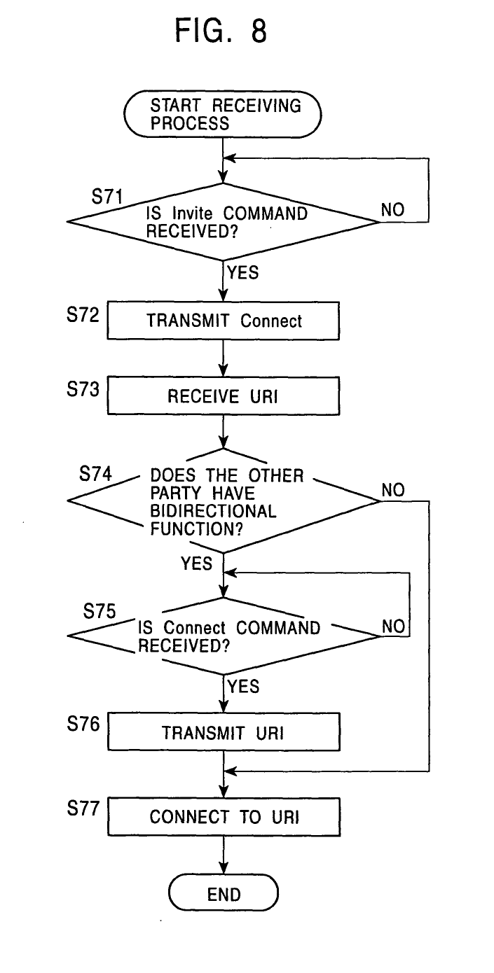

FIG. 8 is a flowchart showing the operation of the terminal 5 (the receiving side) for the processes in FIG. 4. In step S71 (corresponding to step S46 of FIG. 4), the CPU 11 of the terminal 5 determines whether the Invite command is received, and repeats the process of step S71 until the Invite command is received.

When it is determined in step S71 that the Invite command is received, the CPU 11 of the terminal 5 transmits a Connect command to the terminal 2 in step S72 (corresponding to step S48 of FIG. 4). At this time, in the manner described above, since the Accept Connection command is transmitted from the terminal 2 (step S19 of FIG. 4), the CPU 11 of the terminal 5 receives the URI of the device (terminal 5) of the other party in step S73 (corresponding to step S49 of FIG. 4).

In step S74, the CPU 11 of the terminal 5 determines whether the device (the terminal 2) of the other party has a bidirectional function. When it is determined that the device has a bidirectional function (when the item “1. Bidirection/Unidirection”, among the functions of the terminal 2, shown in FIG. 5, which are received in the process of step S42, is “112”, or when the item is “2” and not “1” (when at least the receiving function is possessed)), in step S75 (corresponding to step S50 of FIG. 4), it is determined whether or not the terminal 5 has received the Connect command, and the process of step S75 is repeated until the Connect command is received. Of course, when the Connect command is not received even if a predetermined time has elapsed, the processing may be terminated.

When it is determined in step S75 that the Connect command is received, the CPU 11 of the terminal 5 transmits the URI of the CPU 11 itself stored in the storage section 18 to the device (the terminal 2) of the other party in step S76 (corresponding to step S51 of FIG. 4). In step S77 (corresponding to step S53 of FIG. 4), a connection is made to the URI received in step S73, and the processing is terminated.

When it is determined in step S74 that the device (the terminal 2) of the other party has only the unidirectional function (when the item “1. Bidirection/Unidirection”, among the functions of the terminal 2, shown in FIG. 5, which are received in the process of step S42, is “112”, or when the item is not “2”, but “1” (when the receiving function is not possessed)), the Connect processes of S75 and S76 are skipped (prohibited), the process proceeds to step S77, where the terminal 5 is connected to the URI, and the processing is terminated.

In the foregoing, although the terminal 2 is made to be the transmission side and the terminal 5 is made to be the receiving side, both the terminal 2 and the terminal 5 have a transmission and receiving function. Therefore, the terminal 2 has a function for performing a receiving process in FIG. 8, and the terminal 5 has a function for performing a transmission process in FIG. 7.

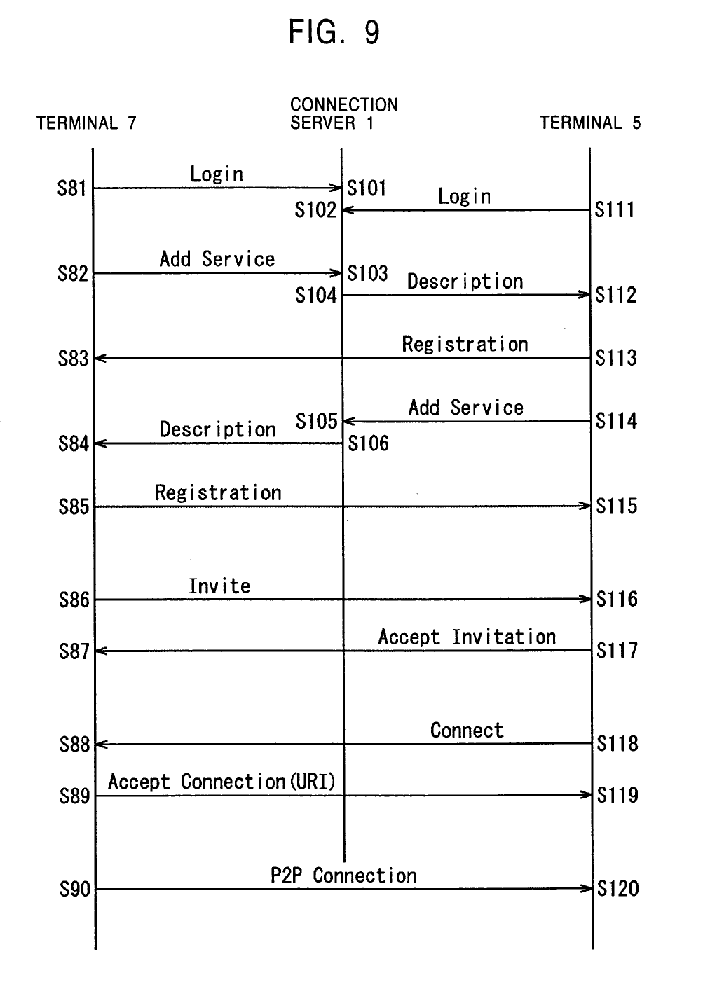

FIG. 9 is a flowchart illustrating a connection process in a case where the transmission side is the terminal 7 having a unidirectional function such that transmission of images is possible, but reception thereof is not possible, and the receiving side is the terminal 5 having a bidirectional function such that images can be transmitted and received.

The processes of steps S81 to S89 of the terminal 7, the processes of steps S101 to S106 of the connection server 1, and the processes of the steps S111 to S119 of the terminal 5 in FIG. 9 are similar to the processes of steps S11 to S19 of the terminal 2, the processes of steps S31 to S36 of the connection server 1, and the processes of the steps S41 to S49 of the terminal 5 in FIG. 4. In FIG. 9, the illustration of the processes of steps S20 and S21 of the terminal 2 and the processes of steps S50 and S51 of the terminal 5 in FIG. 4 is omitted.

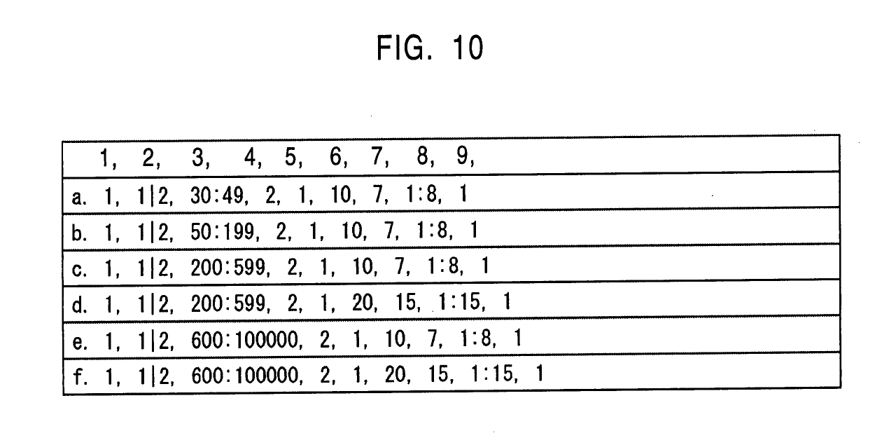

More specifically, in the terminal 7 having a unidirectional function, in step S82 of FIG. 9, items shown in FIG. 10 are registered as the capabilities (functions) of the terminal 7 itself in the connection server 1. Also, in the example of FIG. 10, similarly to FIG. 6, data of nine items are represented by using numerical values, and the item of “1. Bidirection/Unidirection” among them is set at “1” (it is assumed that the image transmission function is possessed, but the receiving function is not possessed).

In this case, the CPU 11 of the terminal 7 does not perform a process for transmitting the Connect command in step S20 of FIG. 4, and therefore, the CPU 11 of the terminal 5 does not perform a process for receiving the Connect command in step S50 of FIG. 4, which corresponds to the transmitting process. Furthermore, since the CPU 11 of the terminal 5 does not perform a process for receiving the Connect command, the CPU 11 does not perform a process for transmitting the Accept Connection command, which corresponds to the receiving process, in step S51 of FIG. 4. Therefore, the CPU 11 of the terminal 7 does not perform a process for receiving the Accept Connection command in step S21 of FIG. 4.

Furthermore, in step S90 (corresponding to step S22 of FIG. 4), the CPU 11 of the terminal 7 performs a transmission process corresponding to step S22 of FIG. 4 (the transmission process based on the URI, which is transmitted in step S89), and the CPU 11 of the terminal 5 performs the corresponding receiving process in step S120 (corresponding to step S52 of FIG. 4). However, since the URI transmission process from the terminal 5 to the terminal 7 is not performed, the transmission process of step S53 of the terminal 5 and the receiving process of step S23 of the terminal 2 in FIG. 4 are not performed.

As a result, even when the other party is a terminal having a unidirectional function, it is possible for the terminal having the bidirectional function to realize a P2P connection by using the same procedure as that when the other party is a terminal having a bidirectional function.

The present invention can be applied to a case in which moving image data, audio data, and other information are transmitted and received as main information by streaming or other methods.

In the foregoing, although the URI for transmitting data is transmitted from the data transmission side to the data receiving side, the URI for receiving data may also be transmitted from the data receiving side to the data transmission side.

Examples of the device determined to not have a data receiving function include a device which does not have its own hardware for receiving data, as well as a device which has hardware for receiving data but whose function is placed in an off state, and a device which cannot receive data because the communication rate does not match with that of the device of the other party.

In the case of a network-capable CE device, etc., the above-described processes can be performed by hardware. Of course, the above-described processes can also be performed by software.

In a case where the series of processes is performed by software, a program forming the software is installed from a network and/or a recording medium into a computer incorporated into dedicated hardware or is installed into a general-purpose computer capable of executing various functions by installing various programs.

The recording medium is formed of a packaged medium composed of the magnetic disk 31 or 81 (including a floppy disk), the optical disk 32 or 82 (including a CD-ROM (Compact Disk-Read Only Memory) or a DVD (Digital Versatile Disk)), the magneto-optical disk 33 or 83 (including an MD (Mini-Disk)), or the semiconductor memory 34 or 84, the recording medium being distributed to provide a program to the user separately to the main unit of the device, as shown in FIGS. 2 and 3. Furthermore, the recording medium is formed of the ROM 12 or 62 in which a program is recorded, a hard disk drive contained in the storage section 18 or 68, which are provided to the user by being preincorporated into the main unit of the device, etc.

In this specification, steps describing a program recorded on a recording medium may be executed chronologically according to the written orders. However, they do not have to be executed chronologically, and may be executed concurrently or individually.

In this specification, the system designates the entire device formed of a plurality of units.

What is claimed is:

1. An information processing system having a first information processing apparatus and a second information processing apparatus for transferring information via a network, said information processing system comprising:
first execution means for performing a connection procedure for transferring main information from said first information processing apparatus to said second information processing apparatus; and
second execution means for determining whether said first information processing apparatus has a bidirectional function for transmitting the main information and for receiving the main information, or has a unidirectional function such that said first information processing apparatus has a transmission function but not a receiving function, and for performing a connection procedure for transferring the main information from said second information processing apparatus to said first information processing apparatus.

2. An information processing system according to claim 1, wherein, in the connection procedure for transferring the main information, one of said first information processing apparatus and said second information processing apparatus transmits, to the other apparatus, information of the connection destination to which the main information is to be transmitted or from which the main information is to be received.

3. An information processing system according to claim 1,
wherein one of said first information processing apparatus and said second information processing apparatus transmits, to the other apparatus, invitation information for inviting a connection, and
wherein the information processing apparatus receiving said invitation information transmits acceptance information indicating that said acceptance is received, to the information processing invitation that has transmitted said invitation information when the invitation based on said invitation information is to be accepted.

4. An information processing system according to claim 1, wherein one of said first information processing apparatus and said second information processing apparatus transmits, to the other apparatus, function information indicating which one of the bidirectional function and the unidirectional function the apparatus itself has.

5. An information processing system according to claim 4, wherein one of said first information processing apparatus and said second information processing apparatus determines whether or not the other party is able to communicate with the apparatus itself when said function information is received from the other party, and when the other party is able to communicate with the apparatus itself, the apparatus itself is registered in the other party.

6. An information processing system according to claim 4, further comprising a third information processing apparatus for transmitting said function information of one of said first information processing apparatus and said second information processing apparatus to the other party via said network.

7. An information processing system according to claim 6,
wherein, to transfer the main information, the connection procedure performed between said first information processing apparatus and said second information processing apparatus is performed via said third information processing apparatus connected to said network, and
wherein the transfer of the main information between said first information processing apparatus and said second information processing apparatus is performed without the intervention of said third information processing apparatus.

8. An information processing system having a first information processing apparatus and a second information processing apparatus for transferring information via a network, said information processing system comprising:
first execution means for performing a connection procedure for transferring main information in a first direction between said first information processing apparatus and said second information processing apparatus; and
second execution means for determining whether at least one of said first information processing apparatus and said second information processing apparatus has a bidirectional function for transmitting the main information and for receiving the main information, or has a unidirectional function such that the apparatus has a transmission function but not a receiving function, and for performing a connection procedure for transferring the main information in a second direction differing from said first direction.

9. An information processing method for use in an information processing system comprising a first information processing apparatus and a second information processing apparatus for transferring information via a network, said information processing method comprising the steps of:
performing a connection procedure for transferring main information from said first information processing apparatus to said second information processing apparatus;
determining whether said first information processing apparatus has a bidirectional function for transmitting the main information and for receiving the main information, or has a unidirectional function such that said first information processing apparatus has a transmission function but not a receiving function; and
performing a connection procedure for transferring the main information from said second information processing apparatus to said first information processing apparatus when said first information processing apparatus has said bidirectional function.

10. An information processing method for use in an information processing system comprising a first information processing apparatus and a second information processing apparatus for transferring information via a network, said information processing method comprising the steps of:
performing a connection procedure for transferring main information in a first direction between said first information processing apparatus and said second information processing apparatus;
determining whether at least one of said first information processing apparatus and said second information processing apparatus has a bidirectional function for transmitting the main information and for receiving the main information, or has a unidirectional function such that the apparatus has a transmission function but not a receiving function; and
performing a connection procedure for transferring the main information in a second direction differing from said first direction when said bidirectional function is possessed.

11. An information processing apparatus for receiving information from a second information processing apparatus via a network, said information processing apparatus comprising:
communication means for transmitting and receiving information; and
control means for performing various processes,
wherein said control means performs:
a first execution process for executing a connection procedure for receiving main information transmitted by said second information processing apparatus;
a determination process for determining whether said second information processing apparatus has a bidirectional function for transmitting the main information and for receiving the main information, or has a unidirectional function such that the second information processing apparatus has a transmission function but not a receiving function; and
a second execution process for executing a connection procedure for said second information processing apparatus to receive the main information transmitted by said information processing apparatus when it is determined in said determination process that said second information processing apparatus has said bidirectional function.

12. An information processing apparatus according to claim 11, wherein, in said second execution process, when it is determined in said determination process that said second information processing apparatus has said unidirectional function, the connection procedure for said second information processing apparatus to receive said main information transmitted by said information processing apparatus is skipped.

13. An information processing apparatus according to claim 11,
wherein, in said first execution process, first connection information for receiving the main information transmitted by said second information processing apparatus is exchanged with said second information processing apparatus, and
wherein, in said second execution process, second connection information for said second information processing apparatus to receive the main information transmitted by said information processing apparatus is exchanged with said second information processing apparatus.

14. An information processing apparatus according to claim 13, wherein, in said first execution process, said first connection information is received from said second information processing apparatus, and
in said second execution process, said second connection information is transmitted to said second information processing apparatus.

15. An information processing apparatus according to claim 14, wherein control means performs a process for communicating with said second information processing apparatus on the basis of at least one of said first connection information and said second connection information.

16. An information processing apparatus according to claim 11, wherein control means performs a process for receiving invitation information for inviting a connection from said second information processing apparatus via said communication means and for transmitting acceptance information indicating that said invitation is accepted, to said second information processing apparatus via said communication means when the invitation based on said invitation information is to be accepted.

17. An information processing apparatus according to claim 11,
wherein control means further performs a process for receiving, via said communication means, function information indicating which one of said bidirectional function and said unidirectional function said second information processing apparatus has, and
wherein said determination process determines which one of said bidirectional function and said unidirectional function said second information processing apparatus has.

18. An information processing apparatus according to claim 17, wherein control means performs a process for determining whether or not communication with said second information processing apparatus is possible when said function information is received, and performs a process for registering said information processing apparatus in said second information processing apparatus when communication with said second information processing apparatus is possible.

19. An information processing apparatus according to claim 17, wherein said control means further performs a process for transmitting said function information of said information processing apparatus to said second information processing apparatus via said communication means.

20. An information processing apparatus according to claim 19, wherein said function information is transmitted to said second information processing apparatus via a third information processing apparatus on said network.

21. An information processing apparatus according to claim 17, wherein said function information of said second information processing apparatus is received via the third information processing apparatus on said network.

22. An information processing apparatus according to claim 11,
wherein, to transfer the main information, the connection procedure performed with said second information processing apparatus is performed via said third information processing apparatus connected to said network, and
wherein, the main information transferred to and from said second information processing apparatus is transferred without the intervention of said third information processing apparatus.

23. An information processing method for receiving information from a communication party via a network, said information processing method comprising:
a first execution step of executing a connection procedure for receiving main information transmitted by said communication party;
a determination step of determining whether the communication party has a bidirectional function for transmitting the main information and for receiving the main information, or has a unidirectional function such that said communication party has a transmission function but not a receiving function; and
a second execution step of executing a connection procedure for transmitting the main information when it is determined in the process of said determination step that said communication party has said bidirectional function.

24. A computer program for allowing a computer to perform a process for receiving information from a communication party via a network, said computer program comprising:
a first execution step of executing a connection procedure for receiving main information transmitted by said communication party;
a determination step of determining whether said communication party has a bidirectional function for transmitting the main information and for receiving the main information, or has a unidirectional function such that said communication party has a transmission function but not a receiving function; and
a second execution step of executing a connection procedure for transmitting said main information to said communication party when it is determined in said determination process that said communication party has said bidirectional function.

25. An information processing apparatus for transmitting information to a second information processing apparatus via a network, said information processing apparatus comprising:
communication means for transmitting and receiving information; and
control means for performing various processes,
wherein said control means performs:
a first execution process for executing a connection procedure for transmitting main information to said second information processing apparatus;
a determination process for determining whether said second information processing apparatus has a bidirectional function for transmitting the main information and for receiving the main information, or has a unidirectional function such that the second information processing apparatus has a transmission function but not a receiving function; and
a second execution process for executing a connection procedure for said information processing apparatus to receive the main information transmitted by said second information processing apparatus when it is determined in said determination process that said second information processing apparatus has said bidirectional function.

26. An information processing apparatus according to claim 25, wherein, in said second execution process, when it is determined in said determination process that said second information processing apparatus has said unidirectional function, the connection procedure for said information processing apparatus to receive said main information transmitted by said second information processing apparatus is skipped.

27. An information processing apparatus according to claim 25,
wherein, in said first execution process, first connection information used by said second information processing apparatus to receive the main information transmitted by said information processing apparatus is exchanged with said second information processing apparatus, and,
wherein, in said second execution process, second connection information used by said information processing apparatus to receive the main information transmitted by said second information processing apparatus is exchanged with said second information processing apparatus.

28. An information processing apparatus according to claim 27,
wherein, in said first execution process, said first connection information is transmitted to said second information processing apparatus, and
wherein, in said second execution process, said second connection information is received from said second information processing apparatus.

29. An information processing apparatus according to claim 28, wherein control means performs a process for communicating with said second information processing apparatus on the basis of at least one of said first connection information and said second connection information.

30. An information processing apparatus according to claim 28,
wherein control means further performs a process for transmitting invitation information, for inviting a connection, to said second information processing apparatus via said communication means, and
wherein said first execution process transmits said first connection information to said second information processing apparatus when the invitation based on said invitation information is accepted.

31. An information processing apparatus according to claim 25,
wherein control means further performs a process for receiving, via said communication means, function information indicating which one of said bidirectional function and said unidirectional function said second information processing apparatus has, the function information being transmitted by said second information processing apparatus, and
wherein said determination process determines, on the basis of said received function information, which one of said bidirectional function and said unidirectional function said second information processing apparatus has.

32. An information processing apparatus according to claim 31, wherein control means performs a process for determining whether or not communication with said second information processing apparatus is possible when said function information is received, and performs a process for registering said information processing apparatus in said second information processing apparatus when communication with said second information processing apparatus is possible.

33. An information processing apparatus according to claim 31, wherein control means further performs a process for transmitting said function information of said information processing apparatus to said second information processing apparatus via said communication means.

34. An information processing apparatus according to claim 33, wherein said function information is transmitted to said second information processing apparatus via a third information processing apparatus on said network.

35. An information processing apparatus according to claim 31 wherein said function information of said second information processing apparatus is received via the third information processing apparatus on said network.

36. An information processing apparatus according to claim 25,
wherein, to transfer the main information, the connection procedure performed with said second information processing apparatus is performed via said third information processing apparatus connected to said network, and
wherein the main information transferred to and from said second information processing apparatus is transferred without the intervention of said third information processing apparatus.

37. An information processing method for transmitting main information to a communication party via a network, said information processing method comprising:
a first execution step of executing a connection procedure for transmitting main information to said communication party;
a determination step of determining whether said communication party has a bidirectional function for transmitting the main information and for receiving the main information, or has a unidirectional function such that said communication party has a transmission function but not a receiving function; and
a second execution step of executing a connection procedure for receiving the main information transmitted by said information processing apparatus when it is determined in the process of said determination step that said communication party has said bidirectional function.

38. A computer program for allowing a computer to perform a process for transmitting information to a communication party via a network, said computer program comprising:
a first execution step of executing a connection procedure for transmitting main information to said communication party;
a determination step of determining whether the communication party has a bidirectional function for transmitting the main information and for receiving the main information, or has a unidirectional function such that said communication party has a transmission function but not a receiving function; and
a second execution step of executing a connection procedure for receiving the main information transmitted by said communication party when it is determined in said determination process that said communication party has said bidirectional function.
